(19) United States
(12) Patent Application Publication
(10) Pub. No.: US 2011/0115847 A1
(43) Pub. Date: May 19, 2011

(54) FLUID EJECTING APPARATUS

(75) Inventors: Takato HAYASHI, Kamiina-gun (JP); Hisashi MIYAZAWA, Okaya-shi (JP)

(73) Assignee: SEIKO EPSON CORPORATION, Tokyo (JP)

(21) Appl. No.: 12/943,266

(22) Filed: Nov. 10, 2010

(30) Foreign Application Priority Data
Nov. 18, 2009 (JP) 2009-262803

(51) Int. Cl. B41J 2/165

(52) U.S. Cl. 347/31

(57) ABSTRACT

Provided is a fluid ejecting apparatus including a fluid ejecting head which includes a nozzle surface having a plurality of opening ends of nozzles arranged thereon and ejects a fluid from the nozzles to a medium, the fluid ejecting apparatus being capable of performing a flushing process in which the fluid is ejected from the nozzles to an absorbing member absorbing the fluid, wherein the absorbing member is a linear member which extends along a nozzle row formed by arranging the plurality of nozzles in a line, and wherein the fluid ejecting apparatus further includes a first movement mechanism which moves the absorbing member between a flushing position facing the nozzles and a retreat position retreating from the nozzle surface in a direction opposite to the fluid ejecting direction.

### CROSS REFERENCES TO RELATED APPLICATIONS

The entire disclosure of Japanese Patent Application No. 2009-262803, filed Nov. 18, 2009, is expressly incorporated by reference herein.

### BACKGROUND

1. Technical Field

The present invention relates to a fluid ejecting apparatus, and particularly, to a flushing process of a printing head.

2. Related Art

An ink jet printer (hereinafter, referred to as “a printer”) is widely known as a fluid ejecting apparatus which ejects ink droplets onto a printing sheet (medium). In this kind of printer, since ink evaporates from a nozzle of a printing head, ink in the nozzle is thickened or solidified, dust is attached to the nozzle, and bubbles are mixed with the ink in the nozzle, which causes an erroneous printing process. Therefore, generally, in a printer, in addition to an ejection process of ejecting ink to a printing sheet, a flushing process of compulsorily ejecting ink in the nozzle to the outside is performed.

In a scanning-type printer, the flushing process is performed by moving a printing head to an area other than a printing area. However, in a printer including a line head in which a printing head is fixed, the printing head cannot move during a flushing process. Therefore, for example, JP-A-2005-119284 proposes a method of ejecting ink toward absorbing members provided in a surface of a sheet transporting belt.

However, in the method disclosed in JP-A-2005-119284, since the plural absorbing members are arranged at the same interval on the sheet transporting belt in accordance with the size of the printing sheet, problems arise in that ink needs to be ejected in every gap between the printing sheets during the flushing process, and in that the size or transporting speed of the printing sheet is limited. In addition, when the flushing process is performed on a planar absorbing member, ink is scattered in the form of a mist due to a wind pressure caused by an operation of ejecting ink droplets, which may contaminate the printing sheet or the sheet transporting belt.

### SUMMARY

An advantage of some aspects of the invention is that it provides a fluid ejecting apparatus capable of simply performing a cleaning (flushing) process within a short time.

In order to solve the above-described problem, some aspects of the invention provide the fluid ejecting apparatus as below.

Provided is a fluid ejecting apparatus including a fluid ejecting head which includes a nozzle surface having a plurality of opening ends of nozzles arranged thereon and ejects a fluid from the nozzles to a medium, the fluid ejecting apparatus being capable of performing a flushing process in which the fluid is ejected from the nozzles to an absorbing member absorbing the fluid, wherein the absorbing member is a linear member which extends along a nozzle row formed by arranging the plurality of nozzles in a line, and wherein the fluid ejecting apparatus further includes a first movement mechanism which moves the absorbing member between a flushing position facing the nozzles and a retreat position retreating from the nozzle surface in a direction opposite to the fluid ejecting direction.

A plurality of the fluid ejecting heads may be disposed with a predetermined gap therebetween in the transportation direction of the medium intersecting the extension direction of the nozzle row, and the retreat position is set to the gap.

The movement mechanism may include a first movement member which moves the absorbing member to be parallel to the nozzle surface, and a second movement member which moves the absorbing member up and down between the nozzle surface and the retreat position.

The second movement member may be formed as a slide rotation body having an inclination surface inclined from the nozzle surface toward the retreat position, and when the inclination surface contacts the absorbing member, the slide rotation body may rotate by the movement force of the absorbing member using the first movement member.

The second movement member may be formed as a driven rotation body having an engagement groove engaging with a part of the absorbing member when the absorbing member moves from the flushing position to a position directly below the retreat position, and when the engagement groove engages with the absorbing member, the driven rotation body may rotate by the movement force of the absorbing member using the first movement member.

The second movement member may be a vertical movement member which holds a part of the absorbing member when the absorbing member moves from the flushing position to a position directly below the retreat position, and lifts the absorbing member to the retreat position in the direction opposite to the fluid ejecting direction.

The movement mechanism may be a swing member which supports the absorbing member at both sides of the fluid ejecting head in the extension direction of the nozzle row, and circulates the absorbing member along a circumferential surface connecting the retreat position to the flushing position.

The fluid ejecting apparatus may further include: a second movement mechanism which moves the absorbing member in the extension direction by rotationally driving a winding rotation body.

The second movement mechanism may move the absorbing member at the retreat position.

### BRIEF DESCRIPTION OF THE DRAWINGS

The invention will be described with reference to the accompanying drawings, wherein like numbers reference like elements.

FIG. 1 is a perspective view illustrating a schematic configuration of a printer of a first embodiment.

FIG. 2 is a perspective view illustrating a lower surface side of a head unit provided in the printer of the first embodiment of the invention.

FIG. 3 is a perspective view illustrating the head unit and the flushing unit provided in the printer of the first embodiment of the invention when seen from the lower side thereof.

FIG. 4 is a schematic diagram illustrating the head unit and the flushing unit provided in the printer of the first embodiment of the invention when seen from the transportation direction of the printing sheet.

FIGS. 5A and 5B are schematic diagrams illustrating an example of an absorbing member provided in the printer of the first embodiment of the invention.

FIGS. 6A to 6D are plan views and cross-sectional views illustrating a movement of the absorbing member of the first embodiment of the invention.

FIG. 7 is a plan view and a cross-sectional view illustrating a retreat position of the absorbing member of the first embodiment.

FIG. 8 is a main cross-sectional view illustrating a movement of the absorbing member of another embodiment.

FIG. 9 is a main cross-sectional view illustrating a movement of the absorbing member of still another embodiment.

FIG. 10 is a main cross-sectional view illustrating a movement of the absorbing member of still another embodiment.

FIG. 11 is a main cross-sectional view illustrating a movement of the absorbing member of still another embodiment.

### DESCRIPTION OF EXEMPLARY EMBODIMENTS

Hereinafter, an embodiment of a fluid ejecting apparatus according to the invention will be described with reference to the accompanying drawings. Further, in the drawings below, the scales of the respective members are appropriately changed so that the respective members have recognizable sizes. Furthermore, in the description below, an ink jet printer (hereinafter, simply referred to as a printer) as an example of the fluid ejecting apparatus of the invention will be described.

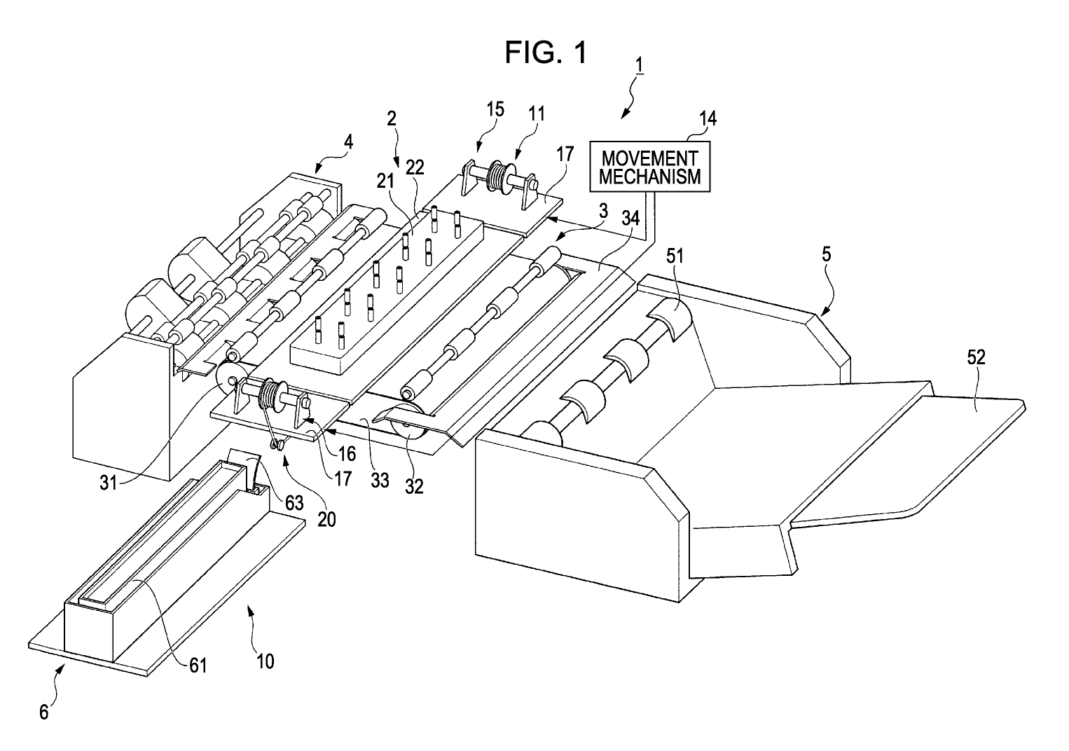

FIG. 1 is a perspective view illustrating a schematic configuration of a printer 1 of this embodiment of the invention. As shown in this drawing, the printer 1 of this embodiment includes a head unit 2, a transportation device 3 which transports a printing sheet (medium), a sheet feeding unit 4 which supplies the printing sheet, a sheet discharging unit 5 which discharges the printing sheet printed by the head unit 2, and a maintenance device 10 which performs a maintenance process on the head unit 2.

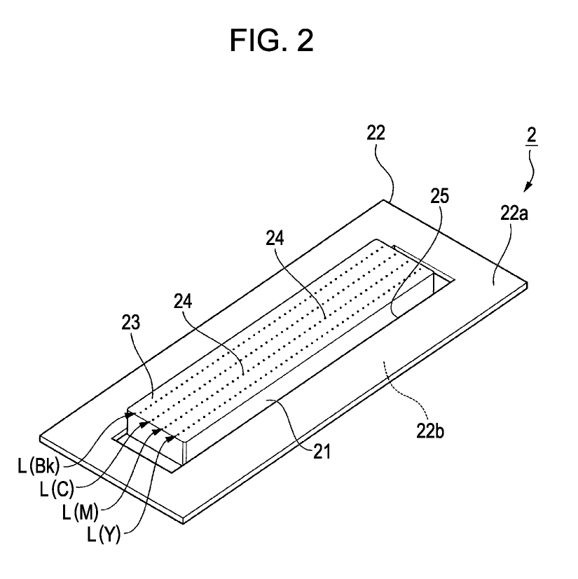

The transportation device 3 holds the printing sheet while having a predetermined gap with respect to the nozzle surface 23 (refer to FIG. 2) of the printing head 21 constituting the head unit 2. The transportation device 3 includes a driving roller portion 31, a driven roller portion 32, and a transportation belt portion 33 which is formed by a plurality of belts wound around the roller portions 31 and 32. In addition, a holding member 34 for holding the printing sheet is installed between the sheet discharging unit 5 and the downstream side (the side of the sheet discharging unit 5) of the transportation direction of the printing sheet of the transportation device 3.

One end of the driving roller portion 31 in the rotation direction is connected to a driving motor (not shown), and is rotationally driven by the driving motor. The rotation force of the driving roller portion 31 is transmitted to the transporting belt portion 33, so that the transporting belt portion 33 is rotationally driven. If necessary, a transmission gear is provided between the driving roller portion 31 and the driving motor. The driven roller portion 32 is a so-called free roller which supports the transporting belt portion 33 and is rotated by the rotational driving operation of the transporting belt portion 33 (the driving roller portion 31).

The sheet discharging unit 5 includes a sheet discharging roller 51 and a sheet discharging tray 52 which holds the printing sheet transported by the sheet discharging roller 51.

FIG. 2 is a perspective view illustrating the lower surface side of the head unit 2. As shown in this drawing, the head unit 2 includes a linear printing head 21 (fluid ejecting head) and an attachment plate 22 supporting the printing head 21.

The printing head 21 is formed in accordance with the effective printing width of the head unit 2, and includes a plurality of nozzles 24 ejecting ink. In addition, the nozzles 24 ejecting the same kind (for example, black B, magenta M, yellow Y, and cyan C) of ink are arranged in the extension direction of the printing head 21 to thereby form one nozzle row L. That is, the printer 1 of this embodiment includes the printing head 21 having nozzle rows L formed by the plurality of nozzles 24 ejecting ink.

In more detail, the printing head 21 has four nozzle rows (L(Y), L(M), L(C), and L(Bk)) corresponding to four colors (yellow (Y), magenta (M), cyan (C), and black (Bk)). As for each of the nozzle rows (L(Y), L(M), L(C), and L(Bk)), the nozzles 24 forming the corresponding nozzle rows (L(Y), L(M), L(C), and L(Bk)) are arranged in the horizontal direction intersecting the transportation direction of the printing sheet, and more desirably arranged in the horizontal direction perpendicular to the transportation direction of the printing sheet.

As shown in FIG. 2, the head unit 2 has a structure in which the printing head 21 is disposed inside an opening 25 formed in the attachment plate 22. In detail, the printing head 21 is fixed to a rear surface 22b of the attachment plate 22 by the use of a screw, so that the nozzle surface 23 protrudes from a front surface 22a of the attachment plate 22 via the opening 25. In addition, since the attachment plate 22 is fixed to a carriage (not shown), the head unit 2 is adapted to be movable to a maintenance position to be described later.

The head unit 2 of this embodiment is adapted to be movable between the printing position and the maintenance position by the use of a carriage (not shown). Here, the printing position is a position where the head unit performs a printing process on the printing sheet while facing the transportation device 3. On the other hand, the maintenance position is a position where the head unit faces a cap unit 6 (refer to FIG. 1) provided in the maintenance device 10 at a position retreating from the upper side of the transportation device 3. The maintenance process (a suction process and a wiping process) for the head unit 2 is performed at the maintenance position.

Returning to FIG. 1, the maintenance device 10 includes the cap unit 6 which performs the suction process on the head unit 2, and a flushing unit 11 which performs a flushing process on the head unit 2.

The cap unit 6 performs the maintenance process such as a capping or suction process on the head unit 2, and includes a cap portion 61 corresponding to the printing head 21. The cap unit 6 is disposed at a position deviated from a printing area of the head unit 2.

The cap portion 61 is adapted to come into contact with the nozzle surface 23 of the printing head 21. Since the cap portion 61 comes into close contact with the nozzle surface 23 of the printing head 21, it is possible to perform a satisfactory capping process, and also to perform a satisfactory suction process of discharging ink from the nozzle surface 23.

In addition, as shown in FIG. 1, the cap unit 6 includes a wiper member 63 which is used in a wiping process of wiping the nozzle surface 23 of the printing head 21.

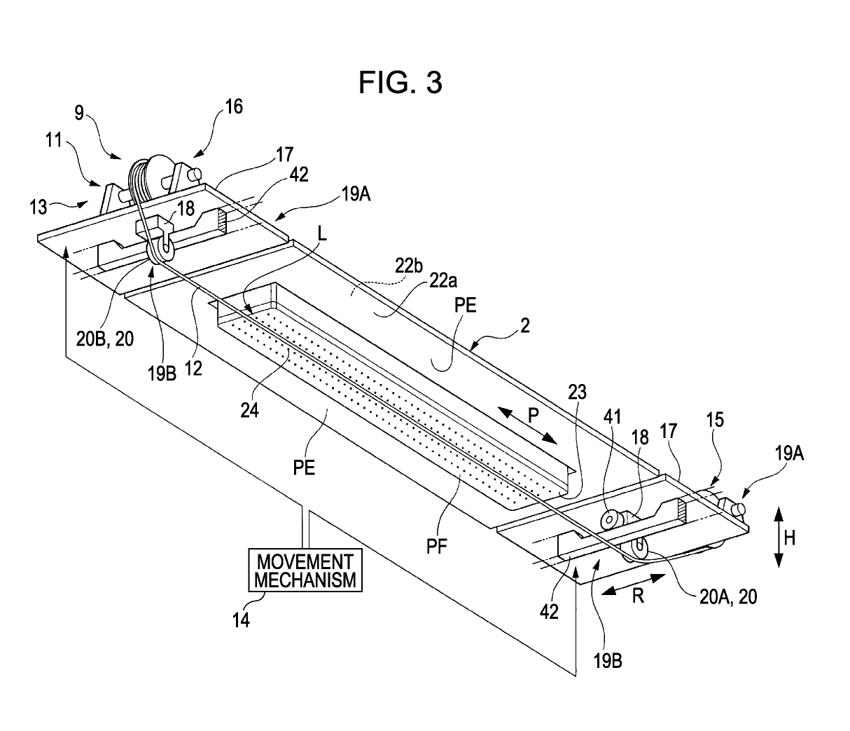

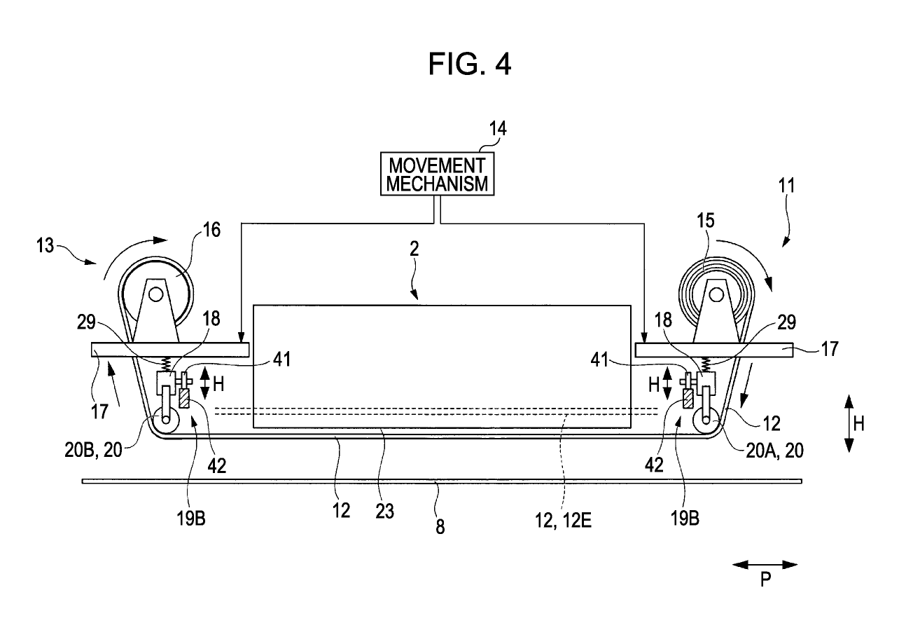

FIG. 3 is a perspective view illustrating the head unit 2 and the flushing unit 11 when seen from the lower side thereof. In addition, FIG. 4 is a schematic diagram illustrating the head unit 2 and the flushing unit 11 when seen from the transportation direction of the printing sheet.

As shown in the drawings, the flushing unit 11 includes an absorbing member 12 (a fluid absorbing member) that absorbs ink ejected during the flushing process, and a support mechanism 9 that supports the absorbing member 12.

The absorbing member 12 is a linear member which absorbs the ink ejected from each of the nozzles 24, and extends along the nozzle rows (L(Y), L(M), L(C), and L(Bk)) formed by the arranged nozzles 24 of respective colors so as to be located between the nozzle surface 23 and the transportation area of the printing sheet.

Then, for example, one absorbing member 12 is installed in the printer 1 of the embodiment.

Next, the detailed configuration of the absorbing member 12 suitably used in the printer 1 according to this embodiment will be described.

For example, the absorbing member 12 may be formed of fiber such as SUS 304, nylon, nylon applied with a hydrophobic coating, aramid, silk, cotton, polyester, ultrahigh molecular weight polyethylene, polyarylate, or Zylon (product name), or compound fiber containing a plurality of these.

In more detail, it is possible to form the absorbing member 12 in such a manner that plural fiber bundles formed of the fiber or the compound fiber are twisted or bound.

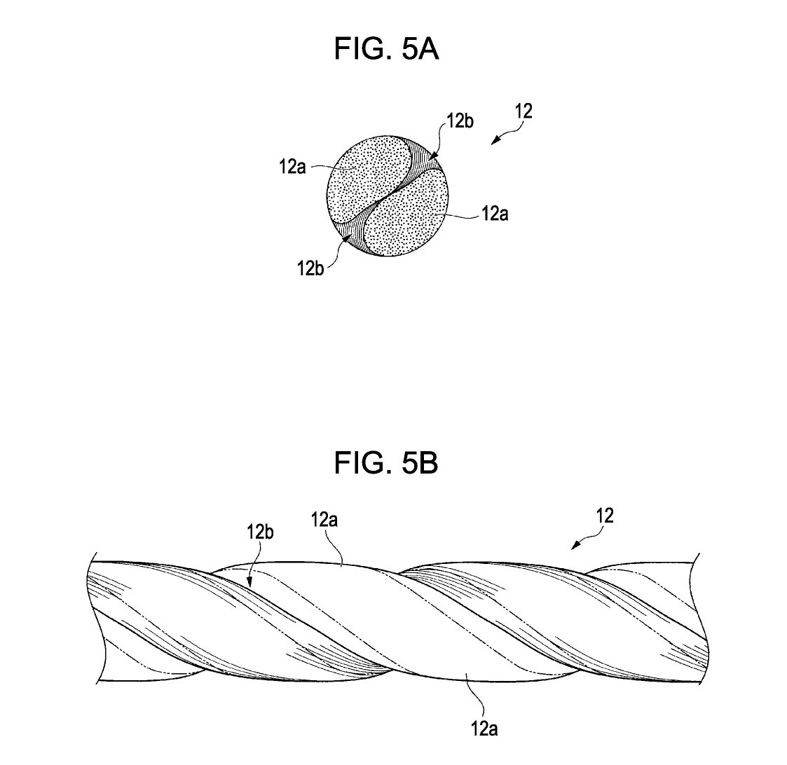

FIGS. 5A and 5B are schematic diagrams showing an example of the absorbing member 12, where FIG. 5A is a sectional view and FIG. 5B is a plan view. As shown in FIGS. 5A and 5B, for example, the absorbing member 12 is formed in such a manner that two (plural) fiber bundles (strings) 12a formed of fiber are twisted. As shown in FIGS. 5A and 5B, in the case where the absorbing member 12 is formed by twisting the plural fiber bundles 12a, since it is possible to store ink in a valley portion 12b formed between the fiber bundles 12a, it is possible to increase an ink absorption amount of the absorbing member 12.

In addition, as an example, a linear member obtained by twisting plural fiber bundles formed of SUS 304, a linear member obtained by twisting plural fiber bundles formed of nylon, a linear member obtained by twisting plural fiber bundles formed of nylon applied with hydrophobic coating, a linear member obtained by twisting plural fiber bundles formed of aramid, a linear member obtained by twisting plural fiber bundles formed of silk, a linear member obtained by twisting plural fiber bundles formed of cotton, a linear member obtained by twisting plural fiber bundles formed of Belima (product name), a linear member obtained by twisting plural fiber bundles formed of Soierion (product name), a linear member obtained by twisting plural fiber bundles formed of Hamilon 03 T (product name), a linear member obtained by twisting plural fiber bundles formed of Dyneema hamilon DB-8 (product name), a linear member obtained by twisting plural fiber bundles formed of Vectran hamilon VB-30, a linear member obtained by twisting plural fiber bundles formed of Hamilon S-5 Core Kevlar Sleeve Polyester (product name), a linear member obtained by twisting plural fiber bundles formed of Hamilon S-212 Core Coupler Sleeve Polyester (product name), a linear member obtained by twisting plural fiber bundles formed of Hamilon SZ-10 Core Zylon Sleeve Polyester (product name), or a linear member obtained by twisting plural fiber bundles formed of Hamilon VB-3 Vectran (product name) may be suitably used as the absorbing member 12.

Since the absorbing member 12 obtained by the fiber of nylon is formed of nylon widely used as a general leveling string, the absorbing member 12 is cheap.

Since the absorbing member 12 using the metallic fiber of SUS has an excellent corrosion resistance property, it is possible to allow the absorbing member 12 to absorb a variety of ink. Also, since the absorbing member 12 has an excellent wear resistance property compared with a resin, it is possible to repeatedly use the absorbing member 12.

The absorbing member 12 using the fiber of ultrahigh molecular weight polyethylene has high breaking strength and chemical resistance, and is strong against an organic solvent, acid, or alkali. Likewise, since the absorbing member 12 using the fiber of ultrahigh molecular weight polyethylene has high breaking strength, it is possible to pull the absorbing member 12 in a high-tension state, and to prevent the absorbing member 12 from being bent. For this reason, in the case where the diameter of the absorbing member 12 is thickened so as to increase the absorbing capacity or the diameter of the absorbing member 12 is not thickened, it is possible to improve the printing precision by narrowing the distance between the printing sheet transporting region and the head 21. In addition, it is expected that the above-described advantage is obtained even in the absorbing member 12 using the fiber of Zylon or an aramid and the absorbing member 12 using the fiber of super-high-molecular polyethylene.

The absorbing member 12 using the fiber of cotton has an excellent ink absorbing property.

In the absorbing member 12, the dropped ink is accommodated and absorbed in the valley portion 12b (see FIGS. 5A and 5B) formed between the fiber bundle 12a and the fiber due to the surface tension.

In addition, a part of the ink dropped onto the surface of the absorbing member 12 directly enters into the absorbing member 12, and the rest moves to the valley portion 12b formed between the fiber bundles 12a. Further, a part of the ink entering into the absorbing member 12 gradually moves in the extension direction of the absorbing member 12 in the inside of the absorbing member 12 so as to be held therein while being dispersed in the extension direction of the absorbing member 12. A part of the ink moving to the valley portion 12b of the absorbing member 12 gradually enters into the absorbing member 12 through the valley portion 12b, and the rest remains in the valley portion 12b so as to be held therein while being dispersed in the extension direction of the absorbing member 12. That is, a part of the ink dropped onto the surface of the absorbing member 12 stays at the dropped position, and the rest is dispersed and absorbed in the vicinity of the dropped position.

In addition, in fact, a material forming the absorbing member 12 provided in the printer 1 is selected in consideration of an ink absorbing property, an ink holding property, a tensile strength, an ink resistance property, formability (a generated amount of fluff or fraying), distortion, cost, or the like.

Further, the ink absorbing amount of the absorbing member 12 is the sum of the amount of ink held between the fibers of the absorbing member 12 and the amount of ink held in the valley portion 12b. For this reason, the material forming the absorbing member 12 is selected so that the ink absorbing amount is sufficiently larger than the amount of the ink ejected during the flushing process in consideration of the exchange frequency of the absorbing member 12.

Furthermore, the amount of ink held between the fibers of the absorbing member 12 and the amount of ink held in the valley portion 12b may be determined by the contact angle between the ink and the fibers, and the capillary force between the fibers depending on the surface tension of the ink. That is, when the absorbing member 12 is formed of thin fibers, the gap between the fibers increases and the surface area of the fiber increases. Accordingly, even when the sectional area of the absorbing member 12 is uniform, the absorbing member 12 is capable of absorbing a larger amount of ink. As a result, in order to obtain more gaps between the fibers, a micro fiber (ultrafine fiber) may be used as a fiber forming the fiber bundle 12a.

However, the ink holding force of the absorbing member 12 decreases since the capillary force decreases due to an increase in the gap between the fibers. For this reason, it is necessary to set the gap between the fibers so that the ink holding force of the absorbing member 12 is of a degree that the ink is not dropped due to the movement of the absorbing member 12.

In addition, the thickness of the absorbing member 12 is set so as to satisfy the above-described ink absorbing amount. In detail, for example, the thickness of the absorbing member 12 is set to be equal to or more than 0.3 mm and equal to or less than 1.0 mm, and more desirably about 0.5 mm.

However, in order to prevent the absorbing member 12 from coming into contact with the head 21 and the printing sheet, the thickness of the absorbing member 12 is set so that the maximum dimension of the section is equal to or less than a dimension obtained by subtracting an amount excluding the displacement amount caused by the bending of the absorbing member 12 from the distance of the sheet transporting region between the printing sheet and the head 21.

In addition, the absorbing member 12 has a width which is larger than the diameter of the nozzle by 15 to 50 times. In this embodiment, the gap between the printing sheet and the nozzle surface 23 of the printing head 21 is about 2 mm, and the nozzle diameter is about 0.02 mm. Accordingly, when the diameter of the absorbing member 12 is 1 mm or less, the absorbing member can be disposed between the nozzle surface and the printing sheet, and the ejected ink can be captured by the absorbing member even when component errors are considered.

In addition, it is desirable that the length of the absorbing member 12 is sufficiently long with respect to the effective printing width of the head unit 2. As described later in detail, in the printer 1 of this embodiment, when the ink is absorbed to the entire area of the absorbing member 12 in a manner that the used-up area (which cannot absorb the ink any more) of the absorbing member 12 is sequentially wound, the absorbing member 12 is exchanged with a replacement when the ink is absorbed to the entire area of the absorbing member 12. For this reason, the exchange period of the absorbing member 12 needs to be set to the time that the absorbing member can be used in the practical application, and desirably the length of the absorbing member 12 needs to be longer by about several hundreds of times than the effective printing width of the head unit 2. However, when the absorbing member 12 is recycled by the cleaning process inside the printer 1, the length of the absorbing member 12 is preferably slightly longer by about twice than the effective printing width of the head unit 2.

Then, the absorbing member 12 is supported by the support mechanism 9.

As shown in FIGS. 3 and 4, the support mechanism 9 includes a movement mechanism 13 and a movement mechanism 14.

The movement mechanism 14 moves the absorbing member 12 between the flushing position opposite the nozzle 24 and the retreat position not opposite the nozzle 24 by moving the absorbing member 12 in the direction (in this embodiment, perpendicular to) intersecting the extension direction of the nozzle row. In addition, the movement mechanism 13 moves the absorbing member 12 to flow along the extension direction of the nozzle row.

As shown in FIGS. 3 and 4, the movement mechanism (a second movement mechanism) 13 includes rotation portions 15 and 16 which are respectively provided on both sides of the head unit 2 in the extension direction P of the nozzle row L so that their rotation shafts are aligned with the transportation direction of the printing sheet on the side of the rear surface 22b of the attachment plate 22 (the opposite side of the nozzle surface 23 of the printing head 21). The rotation portions 15 and 16 are winding mechanisms which are formed in, for example, a bobbin shape and wind the absorbing member 12 thereon. The rotation portions 15 and 16 are installed on a support plate 17 installed inside a casing of the printer 1.

The rotation portions 15 and 16 are connected to a driving motor (not shown), and the absorbing member 12 is supplied therefrom and wound thereon in accordance with the rotation thereof. In the embodiment, one rotation portion 15 is used to supply the absorbing member, and the other rotation portion 16 is used to wind the absorbing member thereon. In addition, the rotation portions 15 and 16 are detachably attached to the printer.

The movement mechanism 14 includes a first movement member 19A which supports the support plate 17 and moves the support plate 17 in the transportation direction of the printing sheet so that the absorbing member 12 for each of the rotation portions 15 and 16 moves while being parallel to the nozzle surface 23 along the transportation direction of the printing sheet (the direction R perpendicular to the extension direction of the nozzle row), and a second movement member 19B which moves the absorbing member 12 up and down between the nozzle surface 23 and the retreat position in the fluid ejecting direction and the vertical movement direction H as the opposite direction thereof.

The support mechanism 9 includes pulleys 20A and 20B. As shown in FIGS. 3 and 4, the two pulleys 20 are installed at the support plate 17 via shaft support portions 18 and springs (biasing portions) 29, and are disposed on both sides of the head unit 2 in the extension direction P of the nozzles L so as to be located on the side of the front surface 22a of the attachment plate 22 (the nozzle surface 23 of the printing head 21). The absorbing member 12 is wound on the rotation portions 15 and 16 of the movement mechanism 13 that are suspended on the pulleys 20A and 20B.

In addition, the support mechanism 9 holds the plurality of absorbing members 12 at an appropriate tension in order not to bend the absorbing members by controlling the rotation speeds of the rotation portions 15 and 16 that are respectively controlled by a control device (not shown). Accordingly, it is possible to prevent the absorbing members 12 from being bent to contact the nozzle surface 23 or the printing sheet.

In this support mechanism 9, the absorbing member 12 is supported by the rotation portions 15 and 16 disposed on the support plate 17 and the pulleys 20A and 20B disposed on the front surface 22a of the attachment plate 22, and the absorbing member 12 supplied from the rotation portion 15 is wound on the rotation portion 16 via the nozzle surface 23 of the printing head 21 in accordance with the operation of the movement mechanism (the second movement mechanism) 13.

As the first movement member 19A moving the support plate 17 in the transportation direction of the printing sheet, for example, a linear slide device may be used. When the support plate 17 moves in the transportation direction of the printing sheet by the movement mechanism (the first movement mechanism) 14, it is possible to change a position of the absorbing member 12 with respect to the head unit 2 (the nozzle row L). Specifically, in the embodiment, the absorbing member 12 is moved between the flushing position and the retreat (printing) position.

On the other hand, the second movement member 19B moving the absorbing member 12 up and down in the vertical movement direction H includes a guide roller 41 which is rotatably installed at the upper portion of the shaft support portion 18 of each of the pulleys 20A and 20B, and a guide rail 42 which engages with the guide roller 41 and the spring (biasing portion) 29 connecting the shaft support portion 18 and the support plate 17.

The guide rail 42 is fixed to a predetermined position with respect to the guide roller 41 or the support plate 17 moved in the transportation direction of the printing sheet by the first movement member 19A. Then, the guide rail 42 has an uneven portion formed thereon so that its surface changes along the vertical movement direction H. In the guide rail 42 of the embodiment, a concave portion 42a is formed in the vertical movement direction H at a position adjacent to the nozzle surface 23 of the printing head 21 in the direction R intersecting the extension direction, that is, the extension direction P of the nozzle row L, and a convex portion 42b is formed in the vertical movement direction H at a position deviating from the nozzle surface 23 in the direction R.

On the other hand, the guide roller 41 engaging with the guide rail 42 is normally biased toward the fluid ejecting direction (the downward direction in the vertical movement direction H) by the spring (biasing portion) 29. Accordingly, the guide roller 41 is firmly pressed so as to follow the guide rail 42 at all times. With such a configuration, the pulleys 20A and 20B connected to the guide roller 41 via the shaft support portion 18 move up and down while being synchronized with the vertical movement in the vertical movement direction H of the guide roller 41 following the concave portion 42a or the convex portion 42b of the guide rail 42 in accordance with the movement of the first movement member 19A. That is, the second movement member 19B moves the absorbing member 12 suspended on the pulleys 20A and 20B in the vertical movement direction H so as to follow the concave portion 42a or the convex portion 42b of the movement guide rail 42.

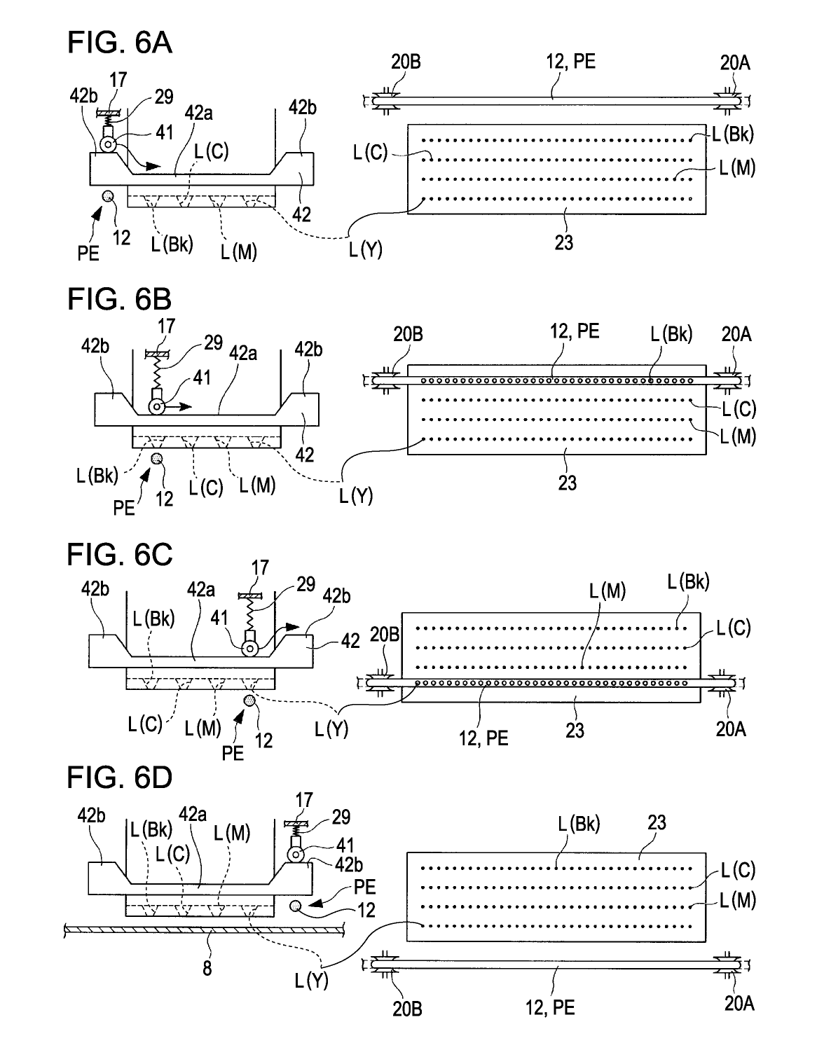

In the embodiment, the position on both sides deviating from the nozzle surface 23 in the direction R intersecting the extension direction P of the nozzle row L is set to the retreat position PE. In the retreat position PE, the absorbing member 12 retreats to a position on the upside of the nozzle surface 23 (the direction opposite to the fluid ejecting direction) in the vertical movement direction H while following the convex portion 42b of the movement guide rail 42 (refer to FIGS. 6A and 6D).

On the other hand, in the embodiment, the position adjacent to the nozzle surface 23 in the direction R intersecting the extension direction P of the nozzle row L is set to the flushing position PF. In the flushing position PF, the absorbing member 12 advances to a position located on the upside of the nozzle surface 23 in the vertical movement direction H (the fluid ejecting direction) and overlapping with the nozzle row L while following the concave portion 42a of the movement guide rail 42 (refer to FIGS. 6B and 6C).

In the printer 1 of the embodiment, all operations are controlled by a control device (not shown). For example, the flushing process is performed between the current printing process and the subsequent printing process, that is, at a timing when the gap between the printing sheets sequentially transported by the transportation device 3 is located directly below the printing head 21.

That is, the movement mechanism 14 of the printer 1 of the embodiment moves the absorbing member 12 to a position directly below the nozzle 24 at a timing when the printing sheet 8 to which the ink is ejected from the nozzle 24 is not directly below the nozzle 24.

FIGS. 6A to 6D are explanatory diagrams sequentially illustrating the flushing process of the printer 1.

For example, the movement mechanism (the first movement mechanism) 14 disposes the absorbing member 12 at the retreat position PE shown in FIG. 6A during the printing process. That is, since the guide roller 41 is located at the convex portion 42b of the guide rail 42 at the retreat position PE, the absorbing member 12 retreats to the upside of the nozzle surface 23 in the vertical movement direction H (the direction opposite to the fluid ejecting direction).

When the gap between the printing sheets 8 reaches a position below the printing head 21, the first movement member 19A is driven so as to move the support plate 17 or the guide roller 41 in the transportation direction of the printing sheet as shown in FIG. 6B. Then, the absorbing member 12 moves to the downside of the nozzle surface 23 in the vertical movement direction H while being synchronized with the guide roller 41 moved to the concave portion 42a of the movement guide rail 42 by the biasing operation of the spring 29 so as to move to the flushing position PF directly below the nozzle row L(Bk). In this way, when the absorbing member 12 moves to the flushing position PF overlapping with the nozzle row L(Bk) directly therebelow, the control device performs the flushing process by ejecting the ink from the nozzle 24 constituting the nozzle row L(Bk).

Subsequently, the movement mechanism 14 moves the absorbing member 12 to the downside of the nozzle surface 23 in the vertical movement direction H in the direction R intersecting the nozzle row L, and performs the flushing process by ejecting the ink from the nozzle 24 even in each of the positions directly below the nozzle row L(C) and the nozzle row L(M). Then, the movement mechanism 14 moves the absorbing member 12 to a position directly below the nozzle row L(Y) as shown in FIG. 6C, and performs the flushing process by ejecting the ink from the nozzle 24 constituting the nozzle row L(Y).

In this way, when the flushing process for all nozzle rows L is completed, the movement mechanism 14 further moves the absorbing member 12 in the direction R intersecting the nozzle row L. Then, as shown in FIG. 6D, the guide roller 41 firmly pressed against the guide rail 42 by the biasing operation of the spring 29 ascends on the inclination surface from the concave portion 42a of the guide rail 42 toward the convex portion 42b to thereby reach the convex portion 42b. When the guide roller 41 moves to the convex portion 42b of the guide rail 42, the absorbing member 12 retreats to the retreat position PE on the upside of the nozzle surface 23 in the vertical movement direction H.

In this way, when the absorbing member 12 retreats to the retreat position PE on the upside of the nozzle surface 23, the printing process on the printing sheet (medium) 8 is resumed. In addition, if all the above-described flushing processes are completed when the gap between the printing sheets passes a position below the printing head 21 while the transportation of the printing sheet using the transportation device 3 is continued, the control device performs the printing process when the subsequent printing sheet is located at a position below the printing head 21 while the transportation of the printing sheet using the transportation device 3 is continued during the flushing process.

On the other hand, when all the above-described flushing processes are not completed while the gap between the printing sheets passes a position below the printing head 21, the control device first stops the transportation of the printing sheet using the transportation device 3 until the flushing process is completed.

In addition, it is desirable to complete the flushing process without stopping the transportation of the printing sheet using the transportation device 3.

For this reason, when it is difficult to complete the flushing process for all nozzle rows L within the time corresponding to the gap between the printing sheets without stopping the transportation of the printing sheet using the transportation device 3, it is desirable to perform the flushing process within the time corresponding to plural gaps between the printing sheets.

Accordingly, it is possible to complete the flushing process without stopping the transportation of the printing sheet using the transportation device 3.

Further, it is desirable that the frequency of the flushing process for each of the nozzle rows L is set to be equal. For this reason, it is desirable that a difference in time until the absorbing member 12 moves to each of the nozzle rows L is set to be minimal (desirably, zero). Accordingly, since it is possible to approximately equalize the time ensured for the flushing process for each of the nozzle rows L, it is possible to uniformize the frequency of the flushing process for each of the nozzle rows L.

Further, the control device may perform a winding operation of winding the ink absorbing portion of the absorbing member 12 by driving the movement mechanism (the second movement mechanism) 13 to move the absorbing member 12 while the flushing process is performed. Accordingly, since the ink ejected from the nozzle row L is ejected to a new portion not absorbing the ink in the absorbing member 12, the ink is rapidly absorbed to the absorbing member 12.

The winding speed of the absorbing member 12 of the movement mechanism 13 is adjusted in accordance with the ink ejection amount. It is desirable that the winding speed increases when the ink ejection amount is large so as to prevent the absorbing member 12 from being saturated. Accordingly, since the absorbing member 12 is wound at a high speed, the ink absorption omission does not occur.

Further, since the absorbing member 12 is wound by the movement mechanism 13, it is possible to absorb the ink using the entire area of the absorbing member 12, and thus to use the absorbing member 12 for a longer period of time without exchanging the absorbing member 12.

On the other hand, the winding operation may be performed by the movement mechanism 13 after the flushing process is terminated and the absorbing member 12 is moved to the retreat position PE by the movement mechanism 13.

Further, even when the flushing process is not performed, the winding operation of the absorbing member 12 may be performed by driving the movement mechanism 13.

Accordingly, it is possible to absorb the ink using an area not absorbing the ink in the absorbing member 12 during the subsequent flushing process.

Further, when the maximal cross-sectional dimension of the absorbing member 12 can be ensured to be sufficiently large with respect to the nozzle diameter, the ink absorption amount of the absorbing member 12 increases. For this reason, the winding operation of the absorbing member 12 may not be performed while performing the flushing process. For example, if the ink does not drip from the absorbing member 12 even after ejecting about 100 droplets of ink to the same position of the absorbing member 12, the absorbing member 12 may be wound after performing the flushing process 10 times.

That is, in the printer 1 of the embodiment, after the ink is ejected to the same area of the absorbing member 12 from the different nozzle 24 (the nozzle 24 constituting the other nozzle row L), the absorbing member 12 may be moved in the extension direction P of the nozzle row L.

Accordingly, since it is possible to absorb a large amount of ink using the absorbing member 12, it is possible to use the absorbing member 12 for a longer period of time.

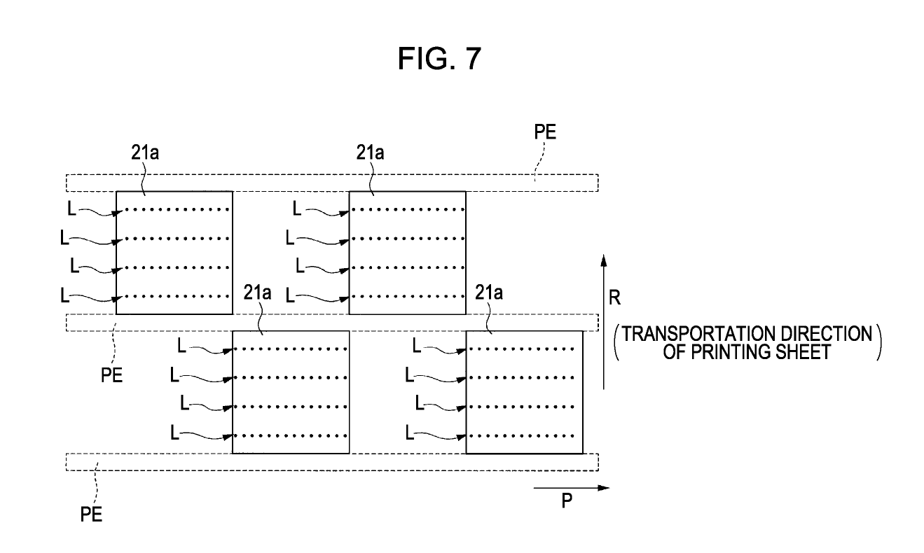

In addition, for example, in the embodiment, a configuration has been described in which a single line head is provided as the printing head 21. However, the invention is not limited thereto, but a plurality of heads may be provided so as to correspond to the effective printing width. At this time, as shown in FIG. 7, the plurality of heads 21a may not be arranged in a line, but may be arranged in zigzag as a whole.

When the plurality of heads 21a is disposed in a zigzag in this way, it is desirable that the gap between the adjacent printing heads 21 is set to the retreat position PE in the direction (the transportation direction of the printing sheet) R perpendicular to the extension direction of the nozzle row L. In this case, the convex portion 42b of the guide rail 42 of the above-described embodiment is formed at three positions, that is, the gap between the printing heads 21 in the direction R and both sides of the printing head 21, and the retreat position PE may be set to the three positions.

Next, another embodiment of the printer (the fluid ejecting apparatus) of the invention, that is, an embodiment showing several variations in the movement mechanism (the first movement mechanism) will be described below.

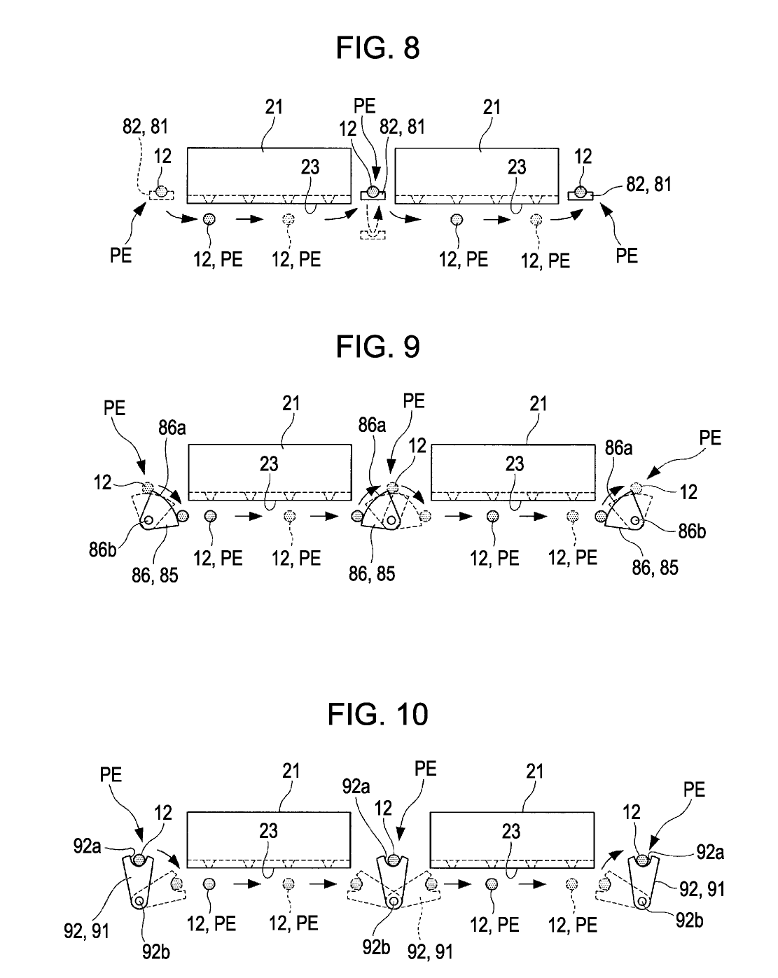

In the embodiment shown in FIG. 8, an arm (a vertical movement member) 82 is provided as a second movement member 81 constituting the movement mechanism (the first movement mechanism) so as to be disposed at the gap between the plurality of printing heads 21 in the transportation direction R of the printing sheet or both ends thereof, and the arm 82 moves the absorbing member 12 located below the nozzle surface 23 of the printing head 21 in the vertical movement direction H to the retreat position PE above the nozzle surface 23 by lifting the absorbing member 12.

In this embodiment, when the absorbing member 12 reaches a position directly below the retreat position PE via the flushing position PF, the absorbing member 12 may be lifted upward in the vertical movement direction H by the arm (the vertical movement member) 82 to reach the retreat position PE above the nozzle surface 23.

In the embodiment shown in FIG. 9, a slide rotation body 86 is provided as a second movement member 85 constituting the movement mechanism (the first movement mechanism), and the slide rotation body 86 includes an inclination surface 86a which is inclined from the nozzle surface 23 of the printing head 21 toward the retreat position PE. When the absorbing member 12 moves in the transportation direction R of the printing sheet and contacts the inclination surface 86a, the slide rotation body 86 rotates about a rotation shaft 86b by the movement force of the absorbing member 12 using the first movement member (not shown) moving the absorbing member 12 in the direction R. Accordingly, the absorbing member 12 moves upward in the vertical movement direction H while contacting the inclination surface 86a, and reaches the retreat position PE above the nozzle surface 23.

Since the inclination surface 86a of the slide rotation body 86 increases the friction force when contacting the absorbing member 12, the slide rotation body 86 is reliably rotated. For this reason, it is desirable that the inclination surface is a rough surface having a fine uneven portion or the like formed thereon.

In the embodiment shown in FIG. 10, a driven rotation body 92 is provided as a second movement member 91 constituting the movement mechanism (the first movement mechanism), where the driven rotation body 92 includes an engagement groove 92a engaging with a part of the absorbing member 12, and rotates about a rotation shaft 92b. In the driven rotation body 92, when the absorbing member 12 moves in the transportation direction R of the printing sheet and the absorbing member 12 contacts the engagement groove 92a, the driven rotation body 92 rotates about the rotation shaft 92b by the movement force of the absorbing member 12 using the first movement member (not shown) moving the absorbing member 12 in the direction R. Accordingly, the absorbing member 12 moves upward in the vertical movement direction H while engaging with the engagement groove 92a, and reaches the retreat position PE above the nozzle surface 23.

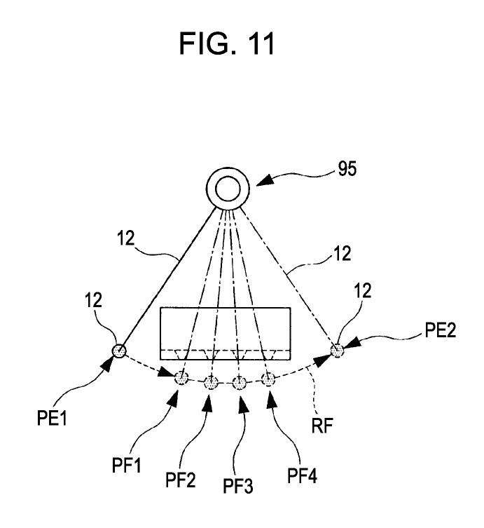

In the embodiment shown in FIG. 11, a swing member 95 is provided which circulates the absorbing member 12 along the circumferential surface RF connecting one retreat position PE1 to the other retreat position PE2 via the flushing positions PF1 to PF4 overlapping with the nozzle rows L, where the absorbing member 12 is located above the nozzle surface 23 while being supported by the swing member at the retreat positions PE1 and PE2 on both sides of the printing head 21 in the extension direction of the nozzle row. When the absorbing member 12 just moves in a swing shape by the swing member 95, the absorbing member 12 freely moves between the retreat positions PE1 and PE2 above the nozzle surface 23 and the flushing positions PF1 to PF4 below the nozzle surface 23.

Further, in the embodiment, since the distance between the opening end of the nozzle and the surface of the absorbing member 12 is different at the flushing positions PF1 to PF4, it is desirable to optimally adjust the force for ejecting the fluid (the ink) for each nozzle.

While the preferred embodiments of the invention are described as above with reference to the accompanying drawings, it is needless to say that the invention is not limited to the preferred embodiments, and the preferred embodiments may be combined with each other. It is apparent that various modifications and corrections can be made by persons skilled in the art within the scope of the technical spirit according to the claims, and it should be, of course, understood that the modifications and corrections are included in the technical scope of the invention.

For example, a cleaning mechanism that cleans the absorbing member 12 may be installed in the printer of this embodiment. In this case, when the cleaning mechanism is disposed on the downstream side of the movement direction of the absorbing member 12 (on the downstream side of the pulley 20B), a cleaning process of cleaning the absorbing member 12 absorbing the ink can be performed. Since the absorbing member 12, which can be used again due to the cleaning process, is wound around the rotation portion 16, the flushing process can be performed again by rotating, for example, the rotation portions 15 and 16 in the reverse direction.

In the above-described embodiments, the configuration is described in which the absorbing members 12 extend in parallel to the extension direction of the nozzle rows. However, the invention is not limited thereto, and the extension direction of the absorbing members 12 may not be perfectly parallel to the extension direction of the nozzle rows. That is, in the invention, the meaning that the absorbing members extend along the extension direction of the nozzle rows includes the case where the extension line extending in the extension direction of the nozzle rows intersects the extension line extending in the extension direction of the absorbing members in the front region as well as the case where the extension direction of the absorbing members is perfectly parallel to the extension direction of the nozzle rows.

In the above-described embodiments, a configuration is described in which the invention is applied to the line head type printer. However, the invention is not limited thereto, but may be applied to a serial type printer.

In the above-described embodiments, a configuration is adopted in which a positional relationship between the absorbing members 12 and the head 21 is changed by moving the absorbing members 12. However, the invention is not limited thereto, but a configuration may be adopted in which a positional relationship between the absorbing members 12 and the head 21 is changed by moving the head 21.

In the above-described embodiments, a configuration is described in which the absorbing members 12 and 72 are located at the sheet transporting region between the printing sheet and the head 21. However, the invention is not limited thereto, but a configuration may be adopted in which the absorbing members 12 and 72 are located at a position below the sheet transporting region during the maintenance process.

In the above-described embodiments, an ink jet printer is adopted, but a fluid ejecting apparatus for ejecting a fluid other than ink or a fluid container for storing the fluid may be adopted. Various fluid ejecting apparatuses including a fluid ejecting head for ejecting a minute amount of liquid droplet may be adopted. In addition, the liquid droplet indicates the fluid ejected from the fluid ejecting apparatus, and includes a liquid having a particle shape, a tear shape, or a linear shape. Further, here, the fluid may be a material which can be ejected from the liquid ejecting apparatus.

For example, a liquid-state material may be used, including a liquid-state material such as sol or gel water having a high or low viscosity, a fluid-state material such as an inorganic solvent, an organic solvent, a liquid, a liquid-state resin, or liquid-state metal (metallic melt), and a material in which a functional material having a solid material such as pigment or metal particle is dissolved, dispersed, or mixed with a solvent in addition to a fluid. In addition, ink or liquid crystal described in the embodiments may be exemplified as a typical example of the fluid. Here, the ink indicates general water-based ink, oil-based ink, gel ink, or hot-melt ink which contains various fluid compositions.

As a detailed example of the fluid ejecting apparatus, for example, a liquid crystal display, an EL (electro-luminance) display, a plane-emission display, a fluid ejecting apparatus for ejecting a fluid containing dispersed or melted materials such as an electrode material or a color material used to manufacture a color filter, a fluid ejecting apparatus for ejecting a biological organic material used to manufacture a biochip, a fluid ejecting apparatus for ejecting a fluid as a sample used as a precise pipette, a silkscreen printing apparatus, or a micro dispenser may be used.

In addition, a fluid ejecting apparatus for ejecting lubricant from a pinpoint to a precise machine such as a watch or a camera, a fluid ejecting apparatus for ejecting a transparent resin liquid such as a UV-curing resin onto a substrate in order to form a minute hemispherical lens (optical lens) used for an optical transmission element or the like, or a fluid ejecting apparatus for ejecting an etching liquid such as an acid liquid or an alkali liquid in order to perform etching on a substrate or the like may be adopted. Further, the invention may be applied to any one of the fluid ejecting apparatuses and a fluid container thereof.

What is claimed is:

1. A fluid ejecting apparatus comprising:
a fluid ejecting head which includes a nozzle surface having a plurality of opening ends of nozzles arranged thereon and ejects a fluid from the nozzles to a medium,
an absorbing member absorbs the fluid that is ejected from the nozzles during a flushing process, and is a linear member which extends along a nozzle row formed by arranging the plurality of nozzles in a line, and
a first movement mechanism which moves the absorbing member between a flushing position facing the nozzles and a retreat position retreating from the nozzle surface in a direction opposite to the fluid ejecting direction.

2. The fluid ejecting apparatus according to claim 1, wherein a plurality of the fluid ejecting heads is disposed with a predetermined gap therebetween in the transportation direction of the medium intersecting the extension direction of the nozzle row, and the retreat position is set to the gap.

3. The fluid ejecting apparatus according to claim 2, wherein the movement mechanism includes a first movement member which moves the absorbing member to be parallel to the nozzle surface, and a second movement member which moves the absorbing member up and down between the nozzle surface and the retreat position.

4. The fluid ejecting apparatus according to claim 3, wherein the second movement member is formed as a slide rotation body having an inclination surface inclined from the nozzle surface toward the retreat position, and when the inclination surface contacts the absorbing member, the slide rotation body rotates by the movement force of the absorbing member using the first movement member.

5. The fluid ejecting apparatus according to claim 3, wherein the second movement member is formed as a driven rotation body having an engagement groove engaging with a part of the absorbing member when the absorbing member moves from the flushing position to a position directly below the retreat position, and when the engagement groove engages with the absorbing member, the driven rotation body rotates by the movement force of the absorbing member using the first movement member.

6. The fluid ejecting apparatus according to claim 3, wherein the second movement member is a vertical movement member which holds a part of the absorbing member when the absorbing member moves from the flushing position to a position directly below the retreat position, and lifts the absorbing member to the retreat position in the direction opposite to the fluid ejecting direction.

7. The fluid ejecting apparatus according to claim 2, wherein the movement mechanism is a swing member which supports the absorbing member at both sides of the fluid ejecting head in the extension direction of the nozzle row, and circulates the absorbing member along a circumferential surface connecting the retreat position to the flushing position.

8. The fluid ejecting apparatus according to claim 1, further comprising:
a second movement mechanism which moves the absorbing member in the extension direction by rotationally driving a winding rotation body.

9. The fluid ejecting apparatus according to claim 8, wherein the second movement mechanism moves the absorbing member at the retreat position.
